(19) United States
(12) Patent Application Publication
(10) Pub. No.: US 2023/0105021 A1
(43) Pub. Date: Apr. 6, 2023

(54) Systems and Methods for Adaptive Network Security Based on Unsupervised Behavioral Modeling

(71) Applicant: Edgio, Inc., Phoenix, AZ (US)

(72) Inventors: Anant Shah, Los Angeles, CA (US); Richard Yew, Ontario, CA (US); Devender Singh, Westminster, CA (US); Revathi Sabanayagam, Torrance, CA (US); Harkeerat Singh Bedi, Los Angeles, CA (US)

(73) Assignee: Edgio, Inc., Phoenix, AZ (US)

(21) Appl. No.: 17/494,156

(22) Filed: Oct. 5, 2021

(51) Int. Cl. H04L 29/06; H04L 12/24

(52) U.S. Cl. CPC H04L 63/1425; H04L 63/20; H04L 41/16; H04L 41/22

(57) ABSTRACT

Provided is an Adaptive Network Security System (“ANSS”) that receives a first set of network data, detects commonality in a set of parameters within the first set of network data using an unsupervised machine learning technique, and models an expected behavior based on the commonality in the set of parameters. The ANSS may determine a threat risk associated with a second set of network data based on an amount of deviation between the set of parameters from the second plurality of network data and the expected behavior, and may perform a particular action from different actions against the second set of network data in response to the set of parameters from the second set of network data deviating from the expected behavior and the threat risk.

### BACKGROUND

Network security may be provided by a patchwork of manually configured security solutions. Each security solution may protect against a different type of network attack. For instance, a rate limiting solution may be used to prevent Distributed Denial of Service (“DDoS”) and/or other volumetric attacks, and a Web Application Firewall (“WAF”) may be used to prevent Structured Query Language (“SQL”) injection and/or malicious packet attacks.

Each security solution may become vulnerable to the very attacks it is supposed to stop when the security solution is not regularly updated and/or is misconfigured with an incorrect attack signature. The security solutions may statically apply the same set of rules to all user equipment (“UEs”), devices, and/or content, thereby preventing the security solutions from automatically adapting to changing UE behavior, network conditions, network traffic, and/or attack variants. Moreover, the effectiveness of the security solutions may be limited to known or configured attacks. New attacks that have not been previously encountered or specifically defined as part of the security solution configuration (e.g., “Zero-day” attacks) may pass through the security solution undetected.

### BRIEF DESCRIPTION OF THE DRAWINGS

FIG. 1 illustrates an adaptive network security example based on unsupervised machine learning in accordance with some embodiments presented herein.

FIG. 2 illustrates an example of unsupervised behavioral modeling in accordance with some embodiments presented herein.

FIG. 3 illustrates an example of determining the threat level for detected anomalous behavior in accordance with some embodiments presented herein.

FIG. 4 illustrates an example of dynamic rule generation in accordance with some embodiments presented herein.

FIG. 5 presents a process for automatically and dynamically detecting anomalous network behavior and performing actions to protect against the anomalous network behavior in accordance with some embodiments presented herein.

FIG. 6 illustrates an example of a centralized architecture for an Adaptive Network Security System (“ANSS”) in accordance with some embodiments presented herein.

FIG. 7 illustrates an example of a distributed architecture for the ANSS in accordance with some embodiments presented herein.

FIG. 8 illustrates example user interface (“UI”) that may be generated in response to a volumetric rule violation.

FIG. 9 illustrates example UI that may be generated in response to anomalous behavior that violates an interarrival rule.

FIG. 10 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Disclosed are systems and methods for adaptive network security based on unsupervised behavioral modeling. The adaptive network security may include performing unsupervised machine learning across network data provided by different user equipment (“UEs”), and developing a model of expected behaviors for the UEs and/or for different content accessed by the UEs based on the unsupervised machine learning. In some embodiments, the unsupervised machine learning may include modeling expected behavior within HyperText Transfer Protocol (“HTTP”) or layer 7 headers and/or messages, Transport Layer Security (“TLS”) or layer 4-6 headers and/or messages, Transmission Control Protocol (“TCP”) or layer 4 headers and/or packets, Internet Protocol (“IP”) or layer 3 headers and/or packets, and/or other fields, parts, or contents of the received network data. The adaptive network security may further include configuring, generating, and/or adapting network security rules and/or policies based on the expected behaviors that are modeled, and/or performing different actions in response to anomalous behavior that deviates from the expected behaviors used to define the rules and/or policies.

The actions implemented in response to the anomalous behavior may vary according to the type of attack that is associated with a set of network data producing the anomalous behavior, the number of parameters within the set of network data that have anomalous values, and/or the amount of variance between the anomalous values of those parameters and the values for expected behaviors defined for the violated rules and/or policies. Accordingly, the actions may protect against HTTP or layer 7 attacks, TLS or layer 4-6 attacks, TCP or layer 4 attacks, IP or layer 3 attacks, and/or network attacks associated with other network protocols or layers within the Open Systems Interconnection (“OSI”) networking model.

In some embodiments, a threat risk or a threat score may be computed based on the number of parameters with anomalous values and/or the variance between the anomalous values and the values for the expected behaviors. In some such embodiments, different actions may be implemented based on the attack type classified for the anomalous behavior and the threat risk or threat score computed for the anomalous behavior.

Accordingly, an Adaptive Network Security System (“ANSS”) may leverage the unsupervised behavioral modeling to determine the patterns, signatures, values, attributes, and/or other indicia of different attacks without a prior labeled example of one or more network data that are used to perpetrate those attacks, and/or may dynamically customize the actions that are taken to prevent attacks, mitigate attacks, and/or provide notifications of suspected attacks as the patterns, signatures, values, attributes, and/or other indicia of the attacks change or are newly discovered. In this manner, the ANSS may automatically adapt to detect and protect against “zero-day” or new attacks, and/or may adapt the rules, policies, and/or protections as network conditions, traffic, and/or attack signatures change without human intervention or manual configuration, reconfiguration, or updating.

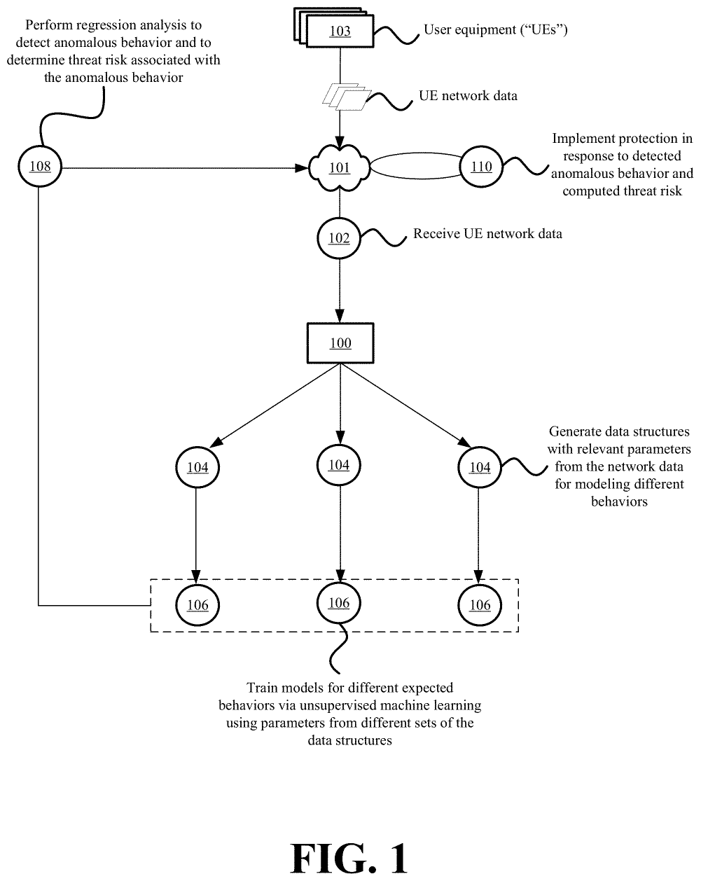

FIG. 1 illustrates an adaptive network security example based on unsupervised machine learning in accordance with some embodiments presented herein. FIG. 1 may include ANSS 100 and site 101. Site 101 may include one or more network-accessible devices and/or systems that are protected from network attacks by ANSS 100. In some embodiments, site 101 may include a Content Delivery Network (“CDN”) Point-of-Presence (“PoP”), a location from which UEs may access different content, services, and/or data, and/or devices or systems of a distributed platform.

As shown in FIG. 1, ANSS 100 may receive (at 102) requests and/or network data that various UEs 103 send to site 101 over a data network. In some embodiments, ANSS 100 may be positioned, implemented, and/or configured to receive (at 102) and inspect the network data prior to the network data reaching an intended destination in site 101. In some embodiments, receiving (at 102) the network data may include aggregating logs from the devices in site 101, wherein the logs track the requests and/or network data received by each device.

ANSS 100 may generate (at 104) one or more data structures that include values or counts that are derived from the values of different parameters in the network data. For instance, ANSS 100 may generate a first data structure that tracks the number of requests originating from one or more UEs 103 and/or for one or more content, a second data structure that tracks the values for specific parameters in the network data issued by UEs 103, and/or a third data structure that tracks the rate and/or timing with which UEs 103 issue requests for different content. In some embodiments, the one or more data structures may include values for parameters that are obtained from pinging, querying, or otherwise obtaining information that is not within the network data from UEs 103. For instance, the content requested by UEs 103 may be embedded with a script that causes the UEs 103 to identify the browser engine, device type, and/or other resources of UEs 103, and/or to track and report user interactions (e.g., scroll speed, clicks, and/or other inputs).

In some embodiments, the data structures may provide a summarized snapshot of the network data arriving at site 101 over a specified interval (e.g., 10 second intervals). For instance, ANSS 100 may filter the received network data to track a subset of parameters from the network data that are used for the behavioral modeling, and/or to derive metrics and/or count from the values of the tracked subset of parameters so that one or more parameters are represented in a condensed or summarized form. The subset of parameters may include different fields from the HTTP or layer 7 headers, TLS or layer 4-6 headers, TCP or layer 4 headers, IP or layer 3 headers, and/or other fields, parts, or contents of the received (at 102) network data. Some specific examples of the subset of tracked parameters may include the user agent, requested host, software versioning, window size, Time-To-Live (“TTL”), TLS version, preferred ciphers, TLS extension, IP address, checksums, sequence number, and/or acknowledgement number. Other parameters not within the subset of tracked parameters may be discarded or excluded from the data structures.

In some embodiments, the data structures may be generated to include parameters for different types of unsupervised behavioral modeling. For instance, ANSS 100 may generate a first data structure to include values for parameters associated with volumetric attacks, and may generate a second data structure to includes values for parameters associated with injection attacks.

In some embodiments, the data structures may be generated for each UE submitting network data, for each content that is requested or accessed, and/or for combinations thereof (e.g., a set of UEs associated with a particular subnet, a particular type of content, etc.). For instance, a first data structure may generated to capture the number of requests submitted by a particular UE during a given interval, the different content accessed by the particular UE, the timing of those requests, header and/or network protocol parameters included with each request, identifying information associated with the particular UE, and/or other variables that may be extracted from the network data sent by the particular UE, the network path traversed by those network data, and/or that may queried from the particular UE.

ANSS 100 may generate (at 106) one or more models that are trained based on the parameters from different sets of the data structures and different artificial intelligence and/or machine learning (“AI/ML”) techniques. Each AI/ML technique may inspect a different set of data structures and may model different patterns, trends, and/or other commonality that are within the data structures.

For instance, ANSS 100 may use a first AI/ML technique to generate a first regression model that predicts expected request volumes originating from different UEs and/or for different content based on a first subset of data structures that includes parameters, counts, and/or other values derived from the received network data that are related to the volume of requests issued by different UEs and/or for different content. Specifically, the first AI/ML technique may identify patterns, trends, and/or other commonality around the frequency and rate with which the different content is requested at different times of day and/or the volume of requests from individual UEs for the different content, and may generate the first regression model to predict expected request volumes by the different UEs and/or for the different content based on the detected patterns, trends, and/or other commonality. The first model may be used to identify anomalous behavior that may be indicative of a DDoS or other volumetric attack.

Similarly, ANSS 100 may use a second AI/ML technique to generate a second regression model that predicts expected header parameters with which different UEs request different content based on a second subset of data structures that includes parameters, counts, and/or other values derived from the received network data that are related to the sequencing and/or frequency with which the content is requested and the header parameters included within the requests. Specifically, the second AI/ML technique may identify patterns, trends, and/or other commonality around the header parameters that are mostly commonly used to request the different content, and may generate the second regression model to predict expected behavior for future requests of the same or related content based on the detected patterns, trends, and/or other commonality. The second model may be used to identify anomalous behavior that may be indicative of a Structured Query Language (“SQL”) injection attack, botnet, or other attack in which the packets contain malicious content or headers with unexpected values (e.g., malformed headers with static values in place of incrementing or changing values, malformed headers with dynamic values in place of static values, and/or other unexpected variation in the requests issued by one or more UEs).

ANSS 100 may perform (at 108) a regression analysis by inputting new requests or network data arriving at site 101 to the generated (at 106) models. The regression analysis may include comparing the actual behavior exhibited by the new requests or network data against the expected behavior of the one or more models. The regression analysis may determine if the new requests or network data exhibit the expected behavior of the one or more models or anomalous behavior that deviates from the expected behavior. For instance, ANSS 100 may detect that a particular UE has significantly increased the rate at which it requests content from site 101, and may further detect that a new UE is requesting particular content with header values that deviated from header values previously used by other UEs to request the particular content.

The regression analysis may include evaluating the threat risk associated with each detected anomalous behavior and/or generating a score for the threat risk. In some embodiments, ANSS 100 may score an anomalous behavior based on the quantity of parameters in the set of network data with the detected anomalous behavior that deviate from expected values for those same parameters in the models, which parameters are determined to be anomalous (e.g., an anomalous user agent parameter may be more indicative of an attack than an anomalous window size parameter), and/or based on the amount of deviation between the values for the parameters in the set of network data and the expected values for those same parameters in the models. For instance, the threat score associated with a UE sending 5 requests more per second than an expected value is much lower than the threat score associated with a UE sending 100 requests per second than the expected value.

ANSS 100 may implement (at 110) different protections in response to detecting anomalous behavior via the regression analysis and/or the computed threat risk associated with that anomalous behavior. For instance, ANSS 100 may generate an alert that notifies a system administrator of first anomalous behavior by a first UE when the first anomalous behavior is classified to be of a low threat (e.g., a threat score of 1), and ANSS 100 may block network data being issued by a second UE when the anomalous behavior of the second UE is classified to be a significant threat (e.g., a threat score of 9).

In some embodiments, the different protections implemented (at 110) by ANSS 100 may include directly affecting the flow of anomalous network data, network data associated with UEs that have been classified as originating the anomalous behaviors, and/or the network data that are directed to different content that is the target of the anomalous behaviors. These protections may include redirecting, dropping, black-holing, and/or modifying network data associated with the detected anomalous behavior. The network data modification may include rewriting or replacing anomalous parameters within the network data.

In some embodiments, the different protections implemented (at 110) by ANSS 100 may include dynamically performing different verifications in response to detected anomalous behavior. For instance, ANSS 100 may require UEs that are associated with anomalous behavior and a low threat risk to perform a Completely Automated Public Turing test to tell Computers and Humans Apart (“CAPTCHA”) or may issue a HashCache or other computational problem for the UEs. If the UEs fail the verification, ANSS 100 may then implement more restrictive protections including blocking or dropping the network data from the unverified UEs.

In some embodiments, the different protections implemented (at 110) by ANSS 100 may include generating alerts, notifications, user interfaces (“UIs”), and/or other messaging from which a security administrator or other user may monitor the anomalous behavior, and/or manually decide to implement protections against the network data associated with the anomalous behavior. The alerts may include links or actions to recommended protections that the security administrator or other user may activate, and ANSS 100 may implement and/or enforce any of the activated attacked protections. In this manner, ANSS 100 may receive confirmation from the security administrator that the anomalous behavior is indeed an attack before taking action to stop that traffic from infiltrating or impacting the targeted system.

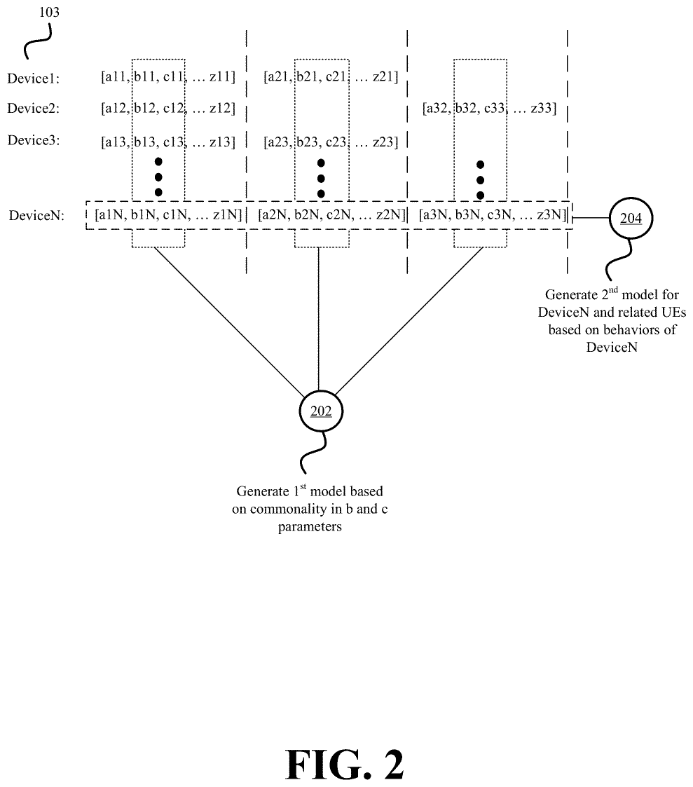

FIG. 2 illustrates an example of the unsupervised behavioral modeling in accordance with some embodiments presented herein. ANSS 100 may track the arrival time for network data issued by different UEs 103, and may group the network data based on the arrival time. For instance, ANSS 100 may track the network data that arrive over 5 second intervals, 1 minute intervals, and/or other intervals.

ANSS 100 may use one or more AI/ML techniques to identify patterns, sequencing, rates, trends, signatures, values, attributes, and/or other indicia of regular or expected behavior from the network data groups. The AI/ML techniques may analyze HyperText Transfer Protocol (“HTTP”) or layer 7 headers, Transport Layer Security (“TLS”) or layer 4-6 headers, Transmission Control Protocol (“TCP”) or layer 4 headers, Internet Protocol (“IP”) or layer 3 headers of the network data for the patterns, sequencing, rates, trends, and/or other commonality. Specifically, the AI/ML techniques may compile different parameter combinations from network data issued by different UEs 103 for different content at different times to detect commonality for an expected behavior. The commonality may include a combination of parameters that have the same or similar values (e.g., values that are within a threshold range of one another), that follow similar sequencing, patterns, frequency, or rates, and/or that have other similarities in their parameter values or in how they are issued.

In some embodiments, ANSS 100 may obtain client-side metrics from UEs 103 based on code that is embedded in content transmitted to UEs 103, scripts running on UEs 103, and/or requests issued from site 101 to UEs 103. The client-side metrics may include tracking the scrolling speed, button presses, inputs, gyroscope, typing speed, and/or other monitored interactions on UEs 103. ANSS 100 may provide the client-side metrics as additional parameters for the AI/ML techniques to include as part of the unsupervised behavioral modeling.

The AI/ML techniques may generate models that represent the identified patterns, sequencing, rates, trends, signatures, values, attributes, and/or other indicia of regular or expected behavior. In some embodiments, the models may be generated for all users, a subset of users, individual users, all content, a subset of content, or individual content. For instance, FIG. 2 illustrates generating (at 202) a first model based on an identified pattern, sequencing, trend, and/or other commonality amongst two parameters of the network data, and generating (at 204) a second model based on an identified pattern, sequencing, trend, and/or other commonality in the network data issued by a particular UE. Accordingly, the first model may be used to predict expected values for the two parameters in subsequent network data from all UEs and/or directed to all content, and the second model may be used to predict future behavior by the particular UE or related UEs. In particular, ANSS 100 may apply the second model to other UEs for which a behavioral model does not exist and that are related or are determined to have a similar classification as the particular UE. For instance, ANSS 100 may apply the second model to predict behavior of a UE that is in the same address subnet or geographic region as the particular UE, a UE that has the same user agent and/or is of the same device type as the particular UE, a UE that requests the same content or the same content type (e.g., video files, images, audio files, documents, etc.) as the particular UE, etc. Similarly, the ANSS 100 may apply the second model to determine if another UE is issuing network data at the same rate or in the same sequencing as the particular UE from which the second model is derived. In this manner, ANSS 100 may generate models that may detect attacks or anomalous behavior from new UEs that have not issued requests or network data to site 101 or ANSS 100, and/or for new content that has not yet been requested.

In some embodiments, the unsupervised behavioral modeling may generate multiple models that predict request volume, cardinality, patterns, interarrival times, and/or other commonality for one or more UEs and/or one or more content. The volume models may predict the expected number of requests from one or more UEs and/or for one or more content at different times. The cardinality models may predict expected values for one or more parameters within network data from one or more UEs and/or for one or more content at different times. The pattern models may predict the pattern of requests issued by one or more UEs and/or for one or more content at different times. The interarrival time models may predict the sequencing, rate, and/or frequency with which different UEs request content and/or different content is requested.

Accordingly, the generated models may apply to network data issued by certain UEs, for certain content, for certain parameters, and/or combinations thereof. ANSS 100 may perform a regression analysis upon receiving network data from the UEs, for the content, having the parameters, and/or the combinations specified for a particular model. ANSS 100 may determine whether the received packets follow or deviate from the expected values and/or behavior of the particular model. One or more deviations with the particular model may be indicative of anomalous behavior and a potential attack. ANSS 100 may then compute the threat risk associated with the detected deviations and/or anomalous behavior by determining the number of parameters that deviate from the expected values or behavior of the particular model, determining the threat risk associated with each anomalous parameter, and/or by calculating the amount of deviation from the expected values or behavior for each deviating parameter.

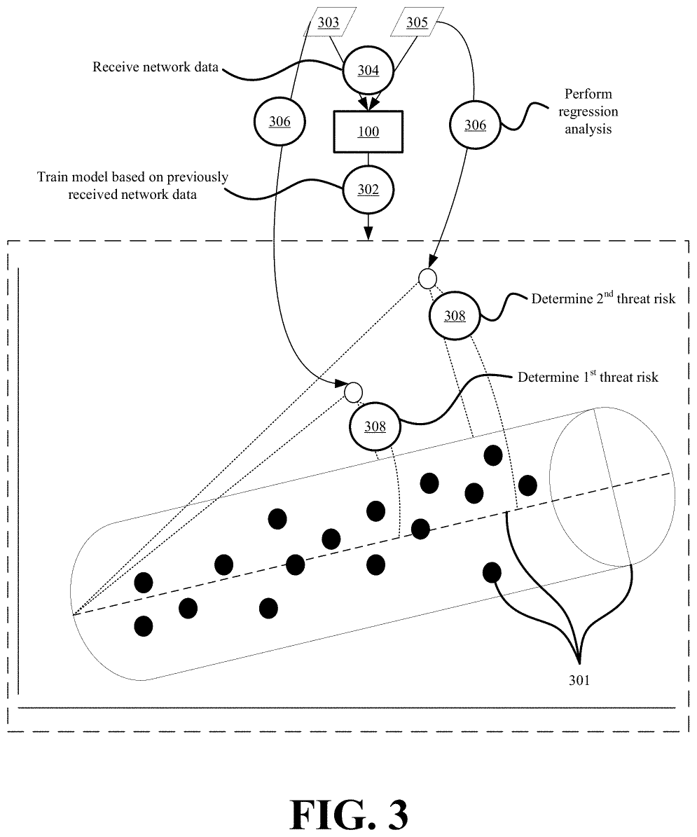

FIG. 3 illustrates an example of determining the threat level for detected anomalous behavior in accordance with some embodiments presented herein. ANSS 100 may train (at 302) one or more models based on the network data submitted by different UEs for different network-accessible content, services, and/or data. The models may predict future expected behaviors by those same UEs or related UEs and/or for the same or related content. FIG. 3 illustrates a modeled expected behavior example 301. In some embodiments, the modeled expected behavior 301 may include a set of expected values for one or more parameters in requests from a set of UEs and/or for a set of content, a set of expected values relating to the frequency, rate of requests, and/or other timing by which the set of UEs submit request or by which different content is requested, and/or other patterns, trends, or commonality that discovered from the unsupervised behavioral modeling performed by ANSS 100. In some embodiments, ANSS 100 may set thresholds, minimum and maximum values, and/or other ranges to represent the modeled expected behavior 301.

ANSS 100 may receive (at 304) new network data 303 and 305 from one of the set of UEs and/or for particular content from the set of content. Since new network data 303 and 305 are from the set of UEs or are directed to the set of content whose behaviors have been modeled (e.g., modeled expected behavior 301), ANSS 100 may perform (at 306) the regression analysis that compares parameters, values, timing, and/or other attributes of new network data 303 and 305 against the modeled expected behavior 301. The comparison may be used to determine whether new network data 303 and 305 exhibit anomalous behavior that deviates from the modeled expected behavior 301, and/or to quantify the threat risk posed by any detected anomalous behavior to the devices and/or systems protected by ANSS 100. As shown in FIG. 3, ANSS 100 may detect that network data 303 and 305 each contain one or more anomalous parameters with values that differ from the expected values set for those parameters in the modeled expected behavior 301.

ANSS 100 may determine (at 308) the threat risk associated with the anomalous parameters by determining the deviation or difference between the anomalous parameters of network data 303 and 305 and the expected values set for those parameters in the modeled expected behavior 301. In some embodiments, determining (at 308) the threat risk may include computing a score based on the number of anomalous parameters, which parameters are determined to be anomalous, and/or the determined deviation or difference. For instance, in response to the deviation or difference between the anomalous parameters of first network data 303 and the modeled expected behavior 301 being less than a threshold amount, ANSS 100 may classify first network data 303 and/or the anomalous behavior associated with first network data 303 as a low threat risk (e.g., a score of 2, wherein the score is within a scale of 0-10 where 0 is a value that represents no attack risk and 10 is a value that represents a high-risk attack). Similarly, in response to the deviation or difference between the anomalous parameters of second network data 305 and the modeled expected behavior 301 being greater than the threshold amount, ANSS 100 may classify second network data 305 and/or the anomalous behavior associated with second network data 305 as a high threat risk (e.g., a score of 7).

In some embodiments, ANSS 100 may dynamically select an action to perform based on the risk classification (e.g., the score for the threat risk) and the one or more parameters from the new request that contributed to the risk classification. For instance, ANSS 100 may select a first action to perform in response to classifying an anomalous value of a first parameter as a threat risk of 10, and may select a second action to perform in response to classifying an anomalous value of a second parameter as a threat risk of 10, wherein the first action may protect against a first type of attack associated with the first parameter having an anomalous value, and the second action may protect against a second type of attack associated with the second parameter. In this case, the first action may include a rate limiting rule that limits the number of requests a UE may issue in a given interval, and the second action may include a blocking rule that prevents requests with a certain anomalous parameter from reaching its intended destination. Similarly, the ANSS 100 may select the first action to perform in response to classifying the anomalous value of the first parameter as a threat risk of 10, and may select a third action to perform in response to classifying the anomalous value of the first parameter as a threat risk of 6. In this case, the first action may include a block rule that blocks all network data from a particular UE, and the second action may include a CAPTCHA, HashCache, or another verification action that the particular UE must perform in order to permit traffic from that particular UE to reach its intended destination.

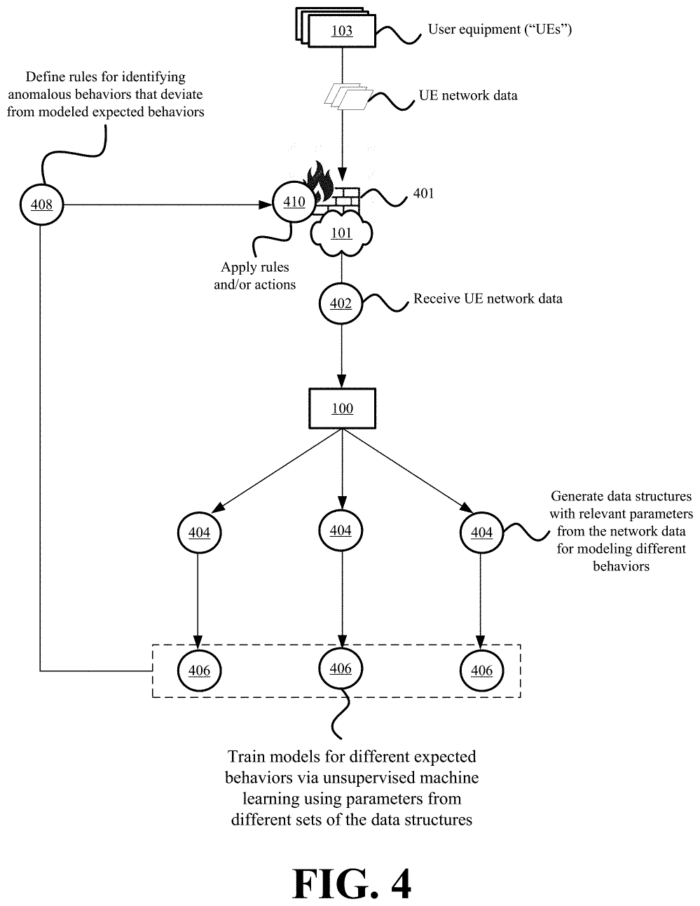

In some embodiments, ANSS 100 may dynamically generate rules for protecting a device or system from detected anomalous behavior and/or associated attacks based on the unsupervised behavioral modeling. FIG. 4 illustrates an example of the dynamic rule generation in accordance with some embodiments presented herein.

ANSS 100 may receive (at 402) requests and/or other network data that different UEs 103 issue to site 101, wherein site 101 is a device or system that uses ANSS 100 to shield itself from various attacks or vulnerabilities. ANSS 100 may parse the requests and/or network data, may generate (at 404) different data structures that include different parameters that are parsed from the network data, and may generate (at 406) one or more models based on the patterns, trends, and/or other commonality detected within the data structures using one or more AI/ML techniques.

ANSS 100 may define (at 408) one or more rules that identify anomalous behavior. Defining (at 408) the rules may include performing a regression analysis to determine expected parameters and/or values for request behavior, UE behavior, content access behavior, and/or other behaviors, and may further include generating (at 408) the one or more rules to detect and protect against behavior that is anomalous to and/or that deviates from the modeled expected behaviors. For example, the modeling may identify that all or a particular set of UEs (e.g., UEs of a particular device type, UEs with network addressing within a particular subnet, etc.) are expected to issue no more than 50 requests per minute based on the unsupervised machine learning and modeling. Accordingly, ANSS 100 may define (at 408) a rate limiting rule that is violated when request rates from individual UEs or UEs within the particular set of UEs exceed 50 requests per minute. As another example, ANSS 100 may determine from the modeling that network data coming from the same UE should arrive at irregular times or intervals, that a first set of network data headers should have variations in certain parameters, and/or that a second set of network data headers should remain static. Accordingly, ANSS 100 may define (at 408) a rule that identifies anomalous UE behavior from a UE that sends network data at fixed times or intervals with static parameters for expected variable parameters (e.g., the first set of parameters) and/or with variable parameters for expected static parameters (e.g., the second set of parameters).

ANSS 100 may apply (at 410) the one or more rules to firewall 401 or another device, system, and/or service that protects site 101 from attacks and/or vulnerabilities. Applying (at 410) the one or more rules may include ANSS 100 configuring, updating, and/or changing the rules that firewall 401 uses to identify anomalous behavior and/or attack traffic.

In some embodiments, ANSS 100 may update the same rule as the traffic pattern entering site 101 changes. For instance, ANSS 100 may increase or decrease a rate limiting rule at different times of day based on different amounts of traffic that are modeled to arrive at site 101 at those different times of day. Specifically, ANSS 100 may define (at 408) and/or apply (at 410) a particular rate limiting rule that is violated when UEs submit more than 10 requests per minute during the morning hours and may update the particular rate limiting rule such that the violation occurs when UEs submit more than 30 requests per minute during evening hours based on a modeling of changing request rates at the different times of day.

In some embodiments, applying (at 410) the one or more rules may include associating different actions to each rule. The actions may include code, instructions, commands, traffic management controls, and/or other operations that firewall 401 is to perform in response to detecting requests, network data, and/or UEs that are in violation of an applied (at 410) rule.

Firewall 401 may inspect and/or compare incoming requests and/or network data against the applied (at 410) rules, and/or may implement (at 412) different actions in response to detecting a rule violation. As noted above, ANSS 100 may determine and associate different actions for different rules. In some embodiments, the actions may be configured at firewall 401 separate from the rules, and ANSS 100 may automatically update or change the rules without changing the actions that are associated with those rules.

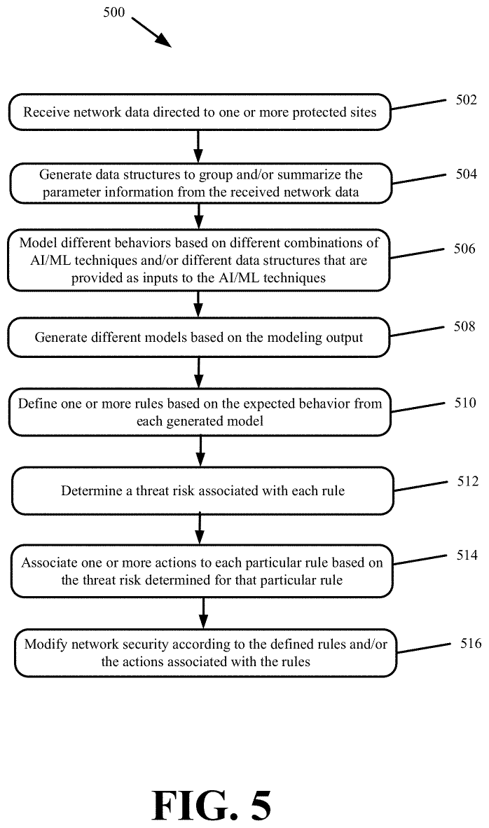

FIG. 5 presents a process 500 for automatically and dynamically detecting anomalous network behavior and performing actions to protect against the anomalous network behavior in accordance with some embodiments presented herein. Process 500 may be implemented by ANSS 100.

Process 500 may include receiving (at 502) network data directed to one or more sites that are protected by ANSS 100. In some embodiments, ANSS 100 may directly receive (at 502) and inspect the network data before the packets are forwarded or routed to intended destinations in the one or more sites. For instance, ANSS 100 may include a firewall device that is implemented as part of or adjacent to a gateway router of each site. In some other embodiments, ANSS 100 may receive (at 502) and inspect the network data based on logs compiled from the one or more sites or based on the network data being forwarded from the one or more sites to ANSS 100.

Process 500 may include generating (at 504) data structures to group and/or summarize the parameter information from the received network data. Generating (at 504) the data structures may include defining sketches, bloom filters, and/or other data structures to track counts, values, and/or derived metrics for one or more parameters from different network data that are pertinent to different anomalous behavior modeling. For instance, ANSS 100 may generate (at 504) a first data structure for modeling volumetric behaviors based on a first set of parameters from network data issued by a first set of UEs and/or targeting a first set of content, and may generate (at 504) a second data structure for modeling cardinality behaviors based on a second set of parameters from network data issued by a second set of UEs and/or targeting a second set of content.

Process 500 may include modeling (at 506) different behaviors based on different combinations of AI/ML techniques and/or different data structures that are provided as inputs to the AI/ML techniques. The modeling (at 506) may include analyzing and clustering the parameters within a set of data structures according to the AI/ML technique selected for that set of data structures and/or a particular behavioral model.

In some embodiments, the modeling (at 506) may include providing the data structures as inputs into one or more neural networks. In some embodiments, the neural networks used to perform the unsupervised behavioral modeling may include a Feedforward Neural Network (“FNN”), a Radial Basis Function Neural Network (“RBFNN”), a Multilayer Perceptron, a Convolutional Neural Network (“CNN”), a Recurrent Neural Network (“RNN”), and/or other neural networks that identify patterns, sequencing, rates, trends, signatures, values, attributes, and/or other indicia of regular or expected request behavior from the data structures. Different neural networks may be used to identify different commonality for different expected behaviors from the parameters within the input data structures.

Process 500 may include generating (at 508) different models based on the modeling (at 506) output. Each model may predict a different behavior of one or more UEs, one or more content, services, and/or data that may be accessed from the sites protected by ANSS 100, and/or other keys or features that may be determined from patterns, sequencing, rates, trends, signatures, values, attributes, and/or other commonality within the received network data and/or data structures. For instance, a model may predict rates, sequencing, frequencies, and/or counts (e.g., request volumes) by which different UEs may request different content at different times, may predict values for different combination of parameters in the requests from different UEs used in requesting different content, and/or may predict other behaviors of different UEs requesting different content.

Process 500 may include defining (at 510) one or more rules based on the expected behavior from each generated (at 508) model. In some embodiments, ANSS 100 may define (at 510) the one or more rules with values or thresholds that deviate from or are at the limits of the expected behavior of each model. For instance, a first model may predict an expected request rate for a first set of content, and ANSS 100 may define (at 510) a first rule that is violated when the request rate for the first set of content exceeds the expected request rate. Similarly, a second model may predict expected header values for requests originated by a first set of UEs, and ANSS 100 may define (at 510) a second rule that is violated when requests from the first set of UEs have header values that deviate from the expected header values.

Process 500 may include determining (at 512) a threat risk associated with each rule. Determining (at 512) the threat risk may include classifying the type of attack that is associated with each rule based on the parameters and/or behaviors that define the rule. For instance, ANSS 100 may classify a first rule as being associated with a volumetric attack when the first rule includes request rate parameters, access time parameters, and/or other parameters that are frequently used in identifying a volumetric attack, and may classify a second rule as being associated with a botnet attack (e.g., SQL injection attacks) when the second rule includes specific parameters that are required to have some static values and other parameters that are required to have some variation. Determining (at 512) the threat risk may further include determining the impact associated with different violations of each rule. ANSS 100 may determine the impact by computing a threat score based on the number of anomalous parameters that are required to violate a rule, a defined severity associated with each anomalous parameter, and/or different amounts or thresholds by which the anomalous parameters violate the rule. More specifically, ANSS 100 may compute the threat score based on an expected impact on the protected services and/or devices when encountering an attack with a particular classification, an expected impact caused by the anomalous parameters, and/or an expected impact caused based on the anomalous parameters deviating from modeled expected parameter by different amounts. For instance, anomalous behavior that violates a volumetric attack rule by no more than 10% of the threshold set for the rule may be indicative of a demand surge for particular content and not an actual attack, and so ANSS 100 may determine (at 512) the risk associated with this violation to be low (e.g., may compute a threat score of 2 in a range of 0-10 with a threat score of 10 representing an attack that may disrupt all services). Anomalous behavior that violates the volumetric attack rule by more than 20% of the set threshold may be a clear indication of a Distributed Denial of Service (“DDoS”) attack, and so ANSS 100 may determine (at 512) the risk associated with this violation to be high (e.g., may compute a threat score of 7 in the range of 0-10). Similarly, anomalous behavior that violates a rule defined for an injection attack (e.g., a SQL injection attack) may be indicative of a serious attack regardless of how much the values associated with the anomalous behavior deviate from the defined rule, and so ANSS 100 may determine (at 512) the risk associated with this violation to be high (e.g., may compute a threat score of 10).

Process 500 may include associating (at 514) one or more actions to each particular rule based on the threat risk determined for that particular rule. Since different violations of a particular rule may be associated with different threat risks, ANSS 100 may associate at least a first action when the violation of the particular rule is less than a first amount or threshold, and a second action when the violation of the particular rule is more than the first amount or threshold and less than a second amount or threshold.

The one or more actions may include alerts that notify security administrators of anomalous behavior suspected to be an attack, traffic management controls that may block, redirect, modify, and/or otherwise alter the delivery of anomalous network data from reaching their intended destination (e.g., a service or device that is protected by ANSS 100), and/or other programmatic operations executed by ANSS 100 to mitigate the harm from anomalous behavior detected in the network data. In some embodiments, the different actions may be defined for different types of attacks. For instance, ANSS 100 may associate (at 514) a first action that blocks network data from reaching their intended destination for volumetric attacks associated with a specific threat risk and for injection attacks, and may associate (at 514) a second action that generates a message or user interface (“UP”) for a security administrator that identifies a set of network data suspected to be originated by a botnet when the sequencing, patterning, and/or inter-arrival times of the set of network data violates a bot detection rule.

Process 500 may include modifying (at 516) network security provided for services and/or devices protected by ANSS 100 according to the defined (at 510) rules and/or the actions associated (at 514) with the rules. In some embodiments, modifying (at 516) the network security may include ANSS 100 updating or adjusting the configuration of a firewall and/or other services or equipment at one or more sites where the protected services and/or devices are located. In some embodiments, ANSS 100 may be integrated as part of the firewall and/or other services or equipment at the one or more sites, and may directly modify the rules and/or actions it uses to inspect inbound traffic from different UEs and to protect against anomalous behavior that violates the defined (at 510) rule by performing the actions associated (at 514) with the violated rules.

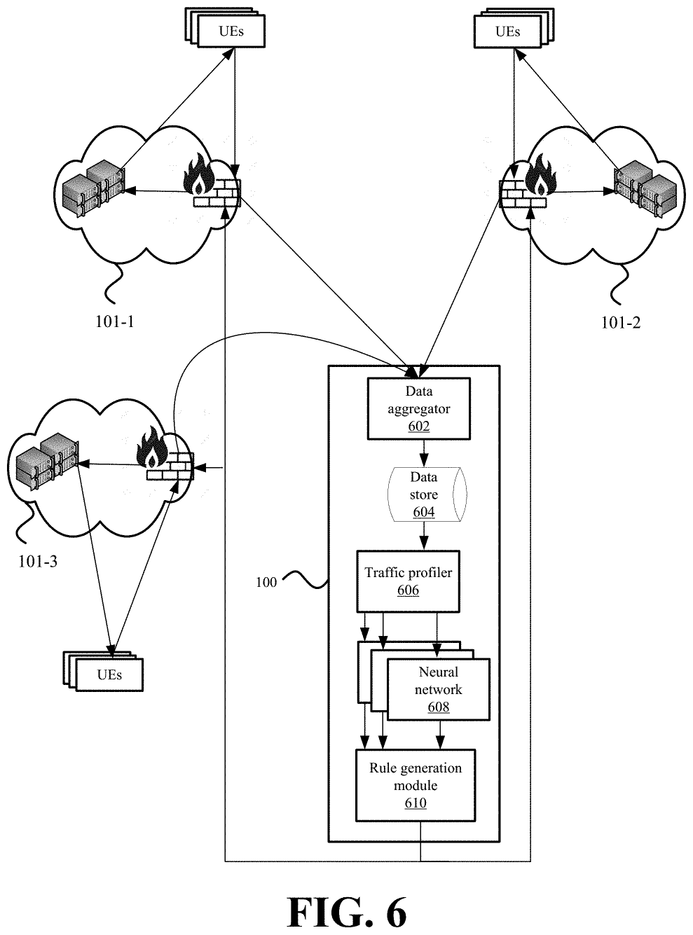

Accordingly, ANSS 100 may be implemented with a centralized and/or distributed architecture. FIG. 6 illustrates an example of a centralized architecture for ANSS 100 in accordance with some embodiments presented herein. With the centralized architecture, ANSS 100 may be connected to and may provide the adaptive network security for different sites 101-1, 101-2, and 101-3 (herein sometimes collectively referred to as “sites 101” or individually referred to as “site 101”).

Each site 101 may represent a different location from which UEs may access services, content, and/or data. Each site 101 may include one or more servers, devices, and/or systems that host and/or provide the services, content, and/or data. Each site 101 may include one or more firewalls and/or other network security services or equipment that protect each site 101 from attack and that may be remotely configured by ANSS 100.

Sites 101 may be part of the same distributed platform. For instance, sites 101 may correspond to different Points-of-Presenece (“PoPs”) of a Content Delivery Network (“CDN”) and/or different node clusters of a cloud service provider.

ANSS 100 may include one or more devices or systems that are communicatively coupled to sites 101 via a data network and network connections that are established with sites 101. ANSS 100 may receive network data that different UEs send to sites 101. In some embodiments, ANSS 100 may receive logs that summarize the network data headers and/or payloads. In some embodiments, sites 101 may forward copies of the network data to ANSS 100.

ANSS 100 may include data aggregator 602, data store 604, traffic profiler 606, one or more neural networks 608, and rule generation module 610. ANSS 100 may include one or more additional devices or systems that are communicatively coupled to one or more networks.

Data aggregator 602 may include a Kafka broker or other module that receives the network data from sites 101. In some embodiments, sites 101 may continuously or periodically push the network data to data aggregator 602. In some other embodiments, data aggregator 602 may continuously or periodically pull logs that contain the network data or summarized information about the received network data from sites 101.

Data aggregator 602 may partition, sort, group, and/or otherwise process the received network data into the different data structures. In some embodiments, data aggregator 602 may sort the received network data and/or different parameters from the received network data into different time-based groups, region-based groups, UE-based groups, content-based groups, and/or other groups. In some embodiments, data aggregator 602 may populate the data structures with summarized values or derived values that are representative of individual values specified for one or more parameters of the network data in a group. The data structures may include sketch structures, bloom filters, and/or other data structures that track counts, defined values, and/or derived values for one or more parameters from different network data.

Data store 604 may store the partitioned, sorted, grouped, and/or otherwise processed network data output by data aggregator 602. For instance, data store 604 may store the data structures that are generated by data aggregator 602 in place of each individual network data received by data aggregator 602. Data store 604 may include a Redis repository, database, and/or other data platform.

Traffic profiler 606 may select and provide different sets of the stored data structures to neural networks 608. Each neural network 608 may generate a model for a different behavior. In some embodiments, each neural network 608 may be configured to detect a different pattern, signature, and/or other commonality from the network data and/or network data parameters that are provided as inputs. For instance, a first neural network 608 may perform unsupervised behavioral modeling for the volume or rate of requests by different UEs and/or for different content, a second neural network 608 may perform unsupervised behavioral modeling for the parameter values of the network data, and/or a third neural network 608 may perform unsupervised behavioral modeling for the interarrival times of the network data. Accordingly, traffic profiler 606 may provide the first neural network 608 with a first set of data structures that track the request rates associated with different UEs and/or different content, may provide the second neural network 608 with a second set of data structures that contain counts for different values that were specified for different parameters, and/or may provide the third neural network 608 with a third set of data structures that track the timing and/or sequencing for network data sent by different UEs and/or for different content.

Rule generation module 610 may dynamically define rules based on the expected behaviors and/or parameter values modeled by neural networks 608. More specifically, rule generation module 610 may perform a regression analysis to dynamically define the rules for detecting anomalous behaviors that violate or deviate from the modeled expected behaviors and/or parameter values. In some embodiments, rule generation module 610 may generate general rules that apply to all UEs and/or all content that is accessible from sites 101, and/or may generate specific rules that apply to specific subsets of UEs and/or specific subsets of content.

By defining different rules for different UEs, ANSS 100 may define different levels of protection to decrease the level of scrutiny for previously-encountered UEs or validated UEs (e.g., use fewer rules and/or rules with less restrictions to monitor behavior of the previously-encountered UEs or validated UEs), and to increase the level of scrutiny for new UEs or UEs that cannot be validated (e.g., use more rules and/or rules with tighter restrictions to monitor behavior of the new UEs or the UEs that cannot be validated). For instance, ANSS 100 may define a first rule that allows UEs with a recognized identifier, IP address, and/or signature to access desired content without performing a CAPTCHA, HashCache, or other verification operation, and may define a second rule that requires UEs without a recognized identifier, IP address, and/or signature to perform the CAPTCHA, HashCache, or other verification operation before being permitted access to the desired content.

Similarly, by defining different rules for different content, ANSS 100 may define different levels of protection to decrease the number or types of attacks screened for a first set of content, and to increase the number of types of attacks screened for a second set of content. For instance, streaming content may be subject to volumetric attacks and not injection attacks or scraping attacks, whereas a merchant website may be subject to volumetric attacks, injection attacks, and scraping attacks. Accordingly, ANSS 100 may enable or activate different rules to provide different protects for the streaming content and the content that is accessible from the merchant website.

In some embodiments, rule generation module 610 may define one or more actions for each rule. In some such embodiments, rule generation module 610 may compute a threat risk or threat score for each rule and/or the anomalous behavior associated with each rule. In some embodiments, rule generation module 610 may compute the threat risk or the threat score based on an expected impact to sites 101, wherein the expected impact may be based on a modeling or definition of disruptions caused by attacks having similar anomalous parameters and/or similar deviations in the values of the anomalous parameters. In some embodiments, rule generation module 610 may compute the threat risk or the threat score based on the number of parameters used to define a rule, a confidence score that quantifies the services that may be affected by each of the defined parameters, and/or the differences between anomalous values for the defined parameters and expected values for the same parameters in the generated models. Rule generation module 610 may define the actions according to the type of attack protected by each rule and the threat risk or threat score associated with different violations of that rule.

Rule generation module 610 may interface with the firewall and/or other network security services or equipment that protect each site 101 from attack, and may dynamically configure the firewall, the network security services, and/or the network security equipment with the generated rules and/or actions. In some embodiments, rule generation module 610 may define new rules to protect against new attacks and/or new anomalous behavior discovered from the unsupervised behavioral modeling. In some embodiments, rule generation module 610 may update existing or previously configured rules to adjust the threshold or values of the rules in response to changing traffic patterns, and/or to change the actions that are implemented in response to different violations of a rule.

In some embodiments, the rules may be used for attack detection, bot detection, traffic management, proxy detection, edge compute cases, and/or detection of other traffic scenarios. The actions may include blocking, redirecting, or otherwise filtering network data that violate a configured rule. The actions may include requiring UEs that violate a configured rule to perform a CAPTCHA, HashCache, or other verification operation. The actions may include rewriting or manipulating the headers, contents, and/or other parts of network data that violate a configured rule. The actions may include providing different error messages in response to network data that violate a configured rule, or sending different notifications, messages, or UIs to security administrators. In some embodiments, rule generation module 610 may generate the notifications, messages, or UIs without a rule violation in order to provide insight as to the behaviors experienced at sites 101.

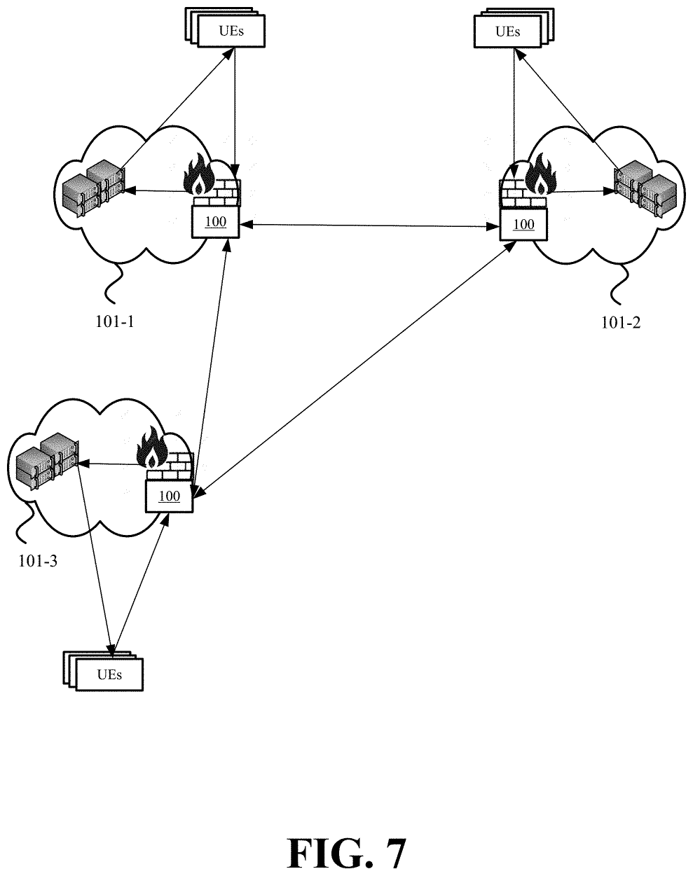

FIG. 7 illustrates an example of a distributed architecture for ANSS 100 in accordance with some embodiments presented herein. The distributed architecture may include integrating a separate instance of ANSS 100 at each site. Specifically, ANSS 100 may be integrated as part of the firewall and/or other network security services or equipment that protect each site 101 from attack. Consequently, ANSS 100 may directly inspect all incoming network data to a site 101, may generate rules that are specifically targeted for the UE and/or request behavior at that site 101, and may implement actions in response to anomalous behavior that violates any of the generated rules. In some such embodiments, ANSS 100 may implement the traffic management controls that affect the routing of network data to and within the associated site 101.

In some embodiments of the distributed architecture, each ANSS 100 instance at each site 101 may exchange data with other ANSS 100 instances at other sites 101. In some such embodiments, each ANSS 100 instance may exchange data structures of received parameters or network data, generated models for expected behaviors based on UE behavior and/or content access behavior at the corresponding site 101, and/or implemented rules and/or attack protections at the corresponding site 101. In this manner, if a new attack is first discovered at first site 101-1, ANSS 100 at first site 101-1 may provide the rule and/or attack protections that protect against the new attack to ANSS 100 at second site 101-2 and third site 101-3 so that those sites 101-2 and 101-3 may also be protected from the new attack without having to train a model using anomalous behavior associated with the new attack.

Moreover, the sharing of information between the distributed ANSS 100 instances may allow for the detection of an attack that is distributed across sites 101. For instance, to mask a scrape attack, an attacker may issue a first set of scraping requests to first site 101-1, a second set of scraping requests to second site 101-2, and a third set of scraping requests to third site 101-3. By sharing the information, ANSS 100 instances may detect the distribution of the scraping requests and may stop additional such requests from the attacker.

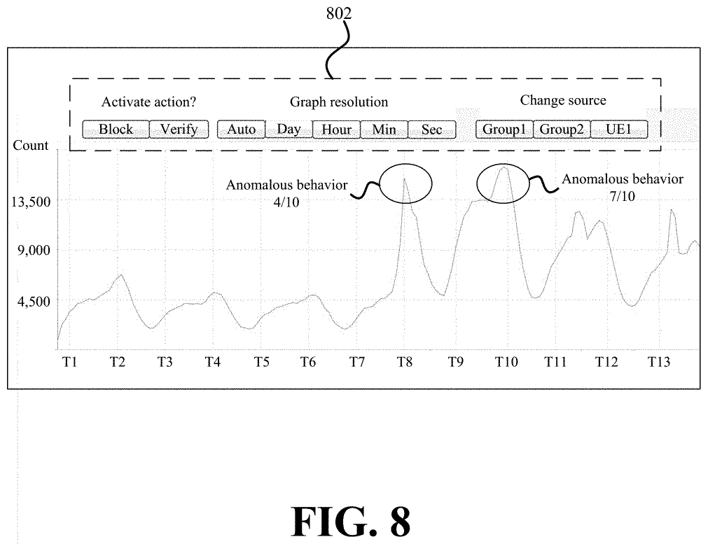

FIG. 8 illustrates example UI 800 that may be generated by ANSS 100 in response to a volumetric rule violation. UI 800 may present request behavior from one or more UEs and/or for one or more content that violates a configured rule. UI 800 may identify the violations by presenting the times at which the violations occurred, the severity of each violation, the UEs or content associated with the violation, and/or other pertinent information for the violation. In some embodiments, UI 800 may include selectable elements 802 that allow a user to customize the presentation. For instance, UI 800 may include selectable elements 802 for showing request rates of individual UEs, of a specific group of UEs, for individual content, for a specific group of content, at different intervals or times, etc. Selectable elements 802 may further include selectable elements for activating different actions and/or protections against the anomalous behavior presented in UI 800. For instance, a first selectable element may including blocking requests issued by UEs identified in UI 800, requiring the UEs to perform a verification operation (e.g., CAPTCHA, HashCache, etc.), and/or performing other actions that limit the ability of the UEs to request the content at issue.

ANSS 100 may generate UI 800 in response to the threat risk associated with the anomalous behavior being low or inconclusive of an attack. For instance, ANSS 100 may provide UI 800 to a security administrator, and the security administrator may inspect the request spikes to determine whether the request spikes are expected as a result of the requested content being new content or popular content, or are unexpected and therefore part of a volumetric attack.

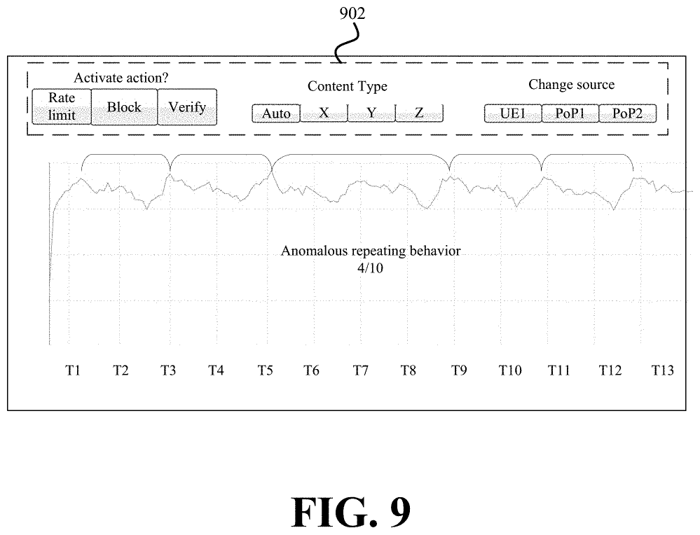

FIG. 9 illustrates example UI 900 that may be generated by ANSS 100 in response to anomalous behavior that violates an interarrival rule. UI 900 may present repeating request behavior of a particular UE, and therefore may be flagged as suspicious or as part of a site-scraping or another attack. ANSS 100 may classify this anomalous behavior as a low threat risk because there is no or little risk of a disruption, downtime, or other impact to site 101 as a result of this anomalous behavior. Accordingly, the rule violated by this anomalous behavior may be associated with an action that generates UI 900 and alerts a security administrator to UI 900. However, if the information being scraping is deemed to be confidential and/or important, then the threat risk may be elevated.

UI 900 may identify the particular UE and/or the anomalous behavior exhibited by the particular UE that violated a configured rule. UI 900 may include selectable elements 902 for customizing the presentation of the anomalous behavior. For instance, selectable elements 902 may be used to isolate the content being requested, parameter values issued in the requests, and/or other information about the requests, the particular UE, and/or the manner with which the requests are issued. The security administrator may decide if the particular UE is a bot, if the particular UE is attempting to exploit a vulnerability, or if the particular UE is performing expected penetration testing, testing some other aspect of site 101, or is acting in a non-malicious manner. The security administrator may activate protections against the particular UE from UI 900 in response to deciding that the anomalous behavior is part of an attack or otherwise unwanted. For instance, the security administrator may toggle a selectable element to block requests from that particular UE for a period of time, require the particular UE to perform a verification operation with each request, impose a specific rate limit for requests from that particular UE, and/or implement other actions.

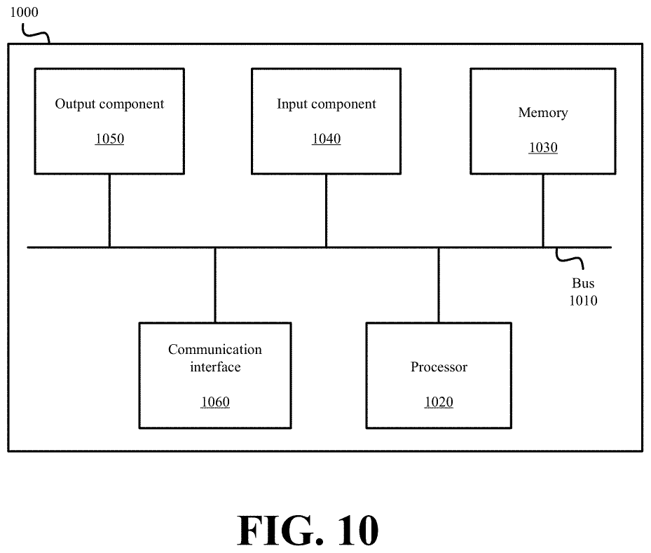

FIG. 10 is a diagram of example components of device 1000. Device 1000 may be used to implement one or more of the devices or systems described above (e.g., ANSS 100, a firewall integrated with ANSS 100 or controlled by ANSS 100, devices within sites 101, etc.). Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
receiving a first plurality of network data;
detecting commonality in a set of parameters within the first plurality of network data;
modeling an expected behavior based on the commonality in the set of parameters;
determining a threat risk associated with a second plurality of network data based on an amount of deviation between the set of parameters from the second plurality of network data and the expected behavior; and
performing a particular action from a plurality of different actions against the second plurality of network data in response to the set of parameters from the second plurality of network data deviating from the expected behavior and the threat risk.

2. The method of claim 1 further comprising:
classifying a type of attack associated with a deviation from the expected behavior based on each parameter within the set of parameters;
selecting a set of actions from the plurality of different actions in response to classifying the attack to a particular type; and
selecting the particular action from the set of actions in response to the threat risk associated with the particular type of attack.

3. The method of claim 1,
wherein the first plurality of network data are issued by a first plurality of user equipment (“UEs”),
wherein the second plurality of network data are issued by a second plurality of UEs that are different than the first plurality of UEs, and
wherein performing the particular action comprises applying the particular action against network data issued by the second plurality of UEs and not applying the particular action against network data issued by the first plurality of UEs.

4. The method of claim 1, wherein performing the particular action comprises:
providing a verification action to each UE that issues network data with the set of parameters deviating from the expected behavior; and
disabling the verification action for each UE that issues network data with the set of parameters matching the expected behavior.

5. The method of claim 1 further comprises:
generating a first data structure based on a first set of parameters from the first plurality of network data that are associated with a first type of network attack; and
generating a second data structure based on a second set of parameters from the first plurality of network data that are associated with a second type of network attack.

6. The method of claim 5, wherein modeling the expected behavior comprises:
training a first model for a first expected behavior based on the first set of parameters from the first data structure; and
training a second model for a second expected behavior based on the second set of parameters from the second data structure.

7. The method of claim 5, wherein modeling the expected behavior comprises:
providing the first data structure as training data for a first artificial intelligence and/or machine learning (“AI/ML”) technique; and
providing the second data structure as different training data for a different second AI/ML technique, and wherein the first AI/ML technique identifies different commonality in the first plurality of network data than the second AI/ML technique.

8. The method of claim 1, wherein performing the particular action comprises:
defining a network security rule based on the expected behavior for the set of parameters; and
configuring a security device at a site intended as a destination for the second plurality of network data with network security rule.

9. The method of claim 8, wherein the network security rule comprises one or more of:
a rate limiting rule that prevents UEs from sending more than a threshold number of requests in a given interval,
an interarrival rule that prevents UEs from repeating a pattern of request, and
a cardinality rule that prevents UEs from sending network data with impermissible values for one or more of the set of parameters.

10. The method of claim 1 further comprising:
selecting a first action from the plurality of different actions as the particular action in response to the threat risk being less than a threshold; and
selecting a second action from the plurality of different actions as the particular action in response to the threat risk being greater than the threshold.

11. The method of claim 10,
wherein the first action comprises an alert that notifies a user of the second plurality of network data that deviate from the expected behavior, and
wherein the second action comprises an action that blocks network data that deviate from the expected behavior.

12. The method of claim 10,
wherein the second action alters a flow of network data subject to the second action, and
wherein the first action is less restrictive than the second action by not altering the flow of network data subject to the first action.

13. The method of claim 1, wherein performing the particular action comprises:
applying the particular action to network data originated from a particular UE that sends or is related to a UE that sends one of the second plurality of network data.

14. The method of claim 1, wherein performing the particular action comprises:
applying the particular action to network data that originate from all UEs and that are directed to particular content.

15. The method of claim 1, wherein performing the particular rule comprises:
generating a user interface (“UI”) that presents one or more of the second plurality of network data as anomalous behavior, and that presents a selectable element for activating a restriction against network data exhibiting the anomalous behavior; and
activating the restriction in response to user selection of the selectable element.

16. A system comprising:
one or more processors configured to:
receive a first plurality of network data;
detect commonality in a set of parameters within the first plurality of network data;
model an expected behavior based on the commonality in the set of parameters;
determine a threat risk associated with a second plurality of network data based on an amount of deviation between the set of parameters from the second plurality of network data and the expected behavior; and
perform a particular action from a plurality of different actions against the second plurality of network data in response to the set of parameters from the second plurality of network data deviating from the expected behavior and the threat risk.

17. The system of claim 16, wherein the one or more processors are further configured to:
classify a type of attack associated with a deviation from the expected behavior based on each parameter within the set of parameters;
select a set of actions from the plurality of different actions in response to classifying the attack to a particular type; and
select the particular action from the set of actions in response to the threat risk associated with the particular type of attack.

18. The system of claim 16, wherein performing the particular action comprises:
providing a verification action to each UE that issues network data with the set of parameters deviating from the expected behavior; and
disabling the verification action for each UE that issues network data with the set of parameters matching the expected behavior.

19. The system of claim 16, wherein the one or more processors are further configured to:
generating a first data structure based on a first set of parameters from the first plurality of network data that are associated with a first type of network attack; and
generating a second data structure based on a second set of parameters from the first plurality of network data that are associated with a second type of network attack.

20. A non-transitory computer-readable medium, storing a plurality of processor-executable instructions to:
receive a first plurality of network data;
detect commonality in a set of parameters within the first plurality of network data;
model an expected behavior based on the commonality in the set of parameters;
determine a threat risk associated with a second plurality of network data based on an amount of deviation between the set of parameters from the second plurality of network data and the expected behavior; and
perform a particular action from a plurality of different actions against the second plurality of network data in response to the set of parameters from the second plurality of network data deviating from the expected behavior and the threat risk.
